(19) United States
(12) Patent Application Publication
(10) Pub. No.: US 2016/0169113 A1
(43) Pub. Date: Jun. 16, 2016

(54) GAS TURBINE TRANSITION PIECE AFT FRAME ASSEMBLY SUPPORTS

(71) Applicant: General Electric Company, Schenectady, NY (US)

(72) Inventors: Mark Carmine Bellino, Greenville, SC (US); Lucas John Stoia, Taylors, SC (US); Christopher Paul Willis, Greenville, SC (US)

(73) Assignee: General Electric Company

(21) Appl. No.: 14/568,394

(22) Filed: Dec. 12, 2014

(51) Int. Cl. F02C 7/24; F01D 25/14; F02C 7/32

(52) U.S. Cl. CPC F02C 7/24; F02C 7/32; F01D 25/145; F05D 2220/32; F05D 2240/90

(57) ABSTRACT

Aft frame assemblies for aft ends of gas turbine transition pieces comprise a body comprising a downstream facing seal surface on an aft end, wherein at least a portion of the downstream facing seal surface configured to be exposed to a combustion discharge stream, a heat shield disposed proximate the aft end of the body, wherein the heat shield is configured to deflect at least a portion of the combustion discharge stream away from the aft end of the body, and, one or more heat shield supports connected to the body and configured to at least partially restrict deflection of the heat shield back towards the body.

### BACKGROUND OF THE INVENTION

The subject matter disclosed herein relates to gas turbine transition pieces and, more specifically, to aft frame assemblies with heat shields for gas turbine transition pieces.

Turbine components, such as buckets (blades), nozzles (vanes), transition pieces, and other hot gas path components of industrial and aircraft gas turbine engines, may be formed of nickel, cobalt or iron-base superalloys with suitable mechanical and environmental properties for turbine operating temperatures and conditions. Because the efficiency of a turbomachine is partially dependent on its operating temperatures, there may be a demand for components such as turbine buckets, nozzles and transition pieces to be capable of withstanding increasingly higher temperatures.

Gas turbines can generally include a compressor, a combustor, one or more fuel nozzles, and a turbine. Air enters the gas turbine through an air intake and is compressed by the compressor. The compressed air is then mixed with fuel supplied by the fuel nozzles. The air-fuel mixture is supplied to the combustor at a specified ration for the combustion. The combustion generates pressurized exhaust gases, which drive blades of the turbine.

The combustor can include a transition piece for confining and direction flow of combustion products (i.e., the combustion discharge stream) from the combustor to a first stage nozzle. The transition piece can include a forward end and an aft end. Located between the aft end of the transition piece and the first stage nozzle can be an aft frame assembly for the transition piece. The combustion discharge stream flows through the transition piece at relatively high temperatures, potentially increasing thermal stress and oxidation at the aft frame, such as along the inner and outer rails. Cooling holes or apertures may be provided in the transition piece aft frame assembly to help redirect the relatively cooler compressor discharge air. A heat shield may additionally or alternatively protect the heat frame assembly by redirecting at least a portion of the combustion discharge stream away therefrom. However, the heat frame may be subject to external forces during manufacturing, modification (e.g., repair), installation, operation and/or transportation.

Accordingly, alternative aft frame assemblies with cooling channels would be welcome in the art.

### BRIEF DESCRIPTION OF THE INVENTION

In one embodiment, an aft frame assembly for an aft end of a gas turbine transition piece is disclosed. The aft frame assembly comprises a body comprising a downstream facing seal surface on an aft end, wherein at least a portion of the downstream facing seal surface configured to be exposed to a combustion discharge stream. The aft frame assembly further comprises a heat shield disposed proximate the aft end of the body, wherein the heat shield is configured to deflect at least a portion of the combustion discharge stream away from the aft end of the body, and, one or more heat shield supports connected to the body and configured to at least partially restrict deflection of the heat shield back towards the body.

In another embodiment, a method for assembling a gas turbine transition piece is disclosed. The method includes connecting an aft frame assembly on an aft end of the gas turbine transition piece. The aft frame assembly comprises a body comprising a downstream facing seal surface on an aft end, at least a portion of the downstream facing seal surface configured to be exposed to a combustion discharge stream, and, a heat shield disposed proximate the aft end of the body, wherein the heat shield is configured to deflect at least a portion of the combustion discharge stream away from the aft end of the body. The method further includes connecting one or more heat shield supports to the body, wherein the one or more heat shield supports are configured to at least partially restrict deflection of the heat shield back towards the body.

These and additional features provided by the embodiments discussed herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the inventions defined by the claims. The following detailed description of the illustrative embodiments can be understood when read in conjunction with the following drawings, where like structure is indicated with like reference numerals and in which:

FIG. 1 is a cross-sectional view of a combustion system according to one or more embodiments shown or described herein;

FIG. 2 is a perspective view of an aft frame assembly for a transition piece with a plurality of heat shield support locations according to one or more embodiments shown or described herein;

FIG. 3 is a side view of a heat shield support for a heat shield with a tolerance gap according to one or more embodiments shown or described herein;

FIG. 4 is a perspective view of the heat shield support of FIG. 3 according to one or more embodiments shown or described herein; and,

FIG. 5 is a method for assembling a gas turbine transition piece according to one or more embodiments shown or described herein.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

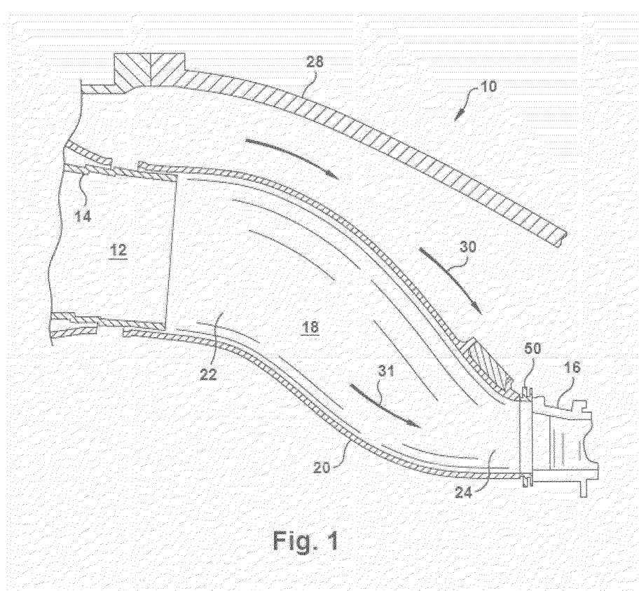

Referring now to FIG. 1, a cross-sectional view of a combustion system 10 is illustrated. Components of the combustion system 10 include a transition piece 18 for enclosing and confining combustion products for flow from a combustor 12 of a gas turbine to a first stage nozzle 16. It should be appreciated that there is an annular array of combustors 12 for generating and flowing hot gases to an annular array of nozzles 16, one of each of such combustors 12, nozzles 16 and transition pieces 18 being illustrated. Also illustrated is a portion of the compressor discharge casing 28. During operation, compressor discharge air 30 may be provided within the space between the casing 28 and the combustor liner 14 and transition piece 18 to cool components of the combustion system 10 and as a source of dilution air.

The transition piece 18 can include an enclosure 20 for confining and directing the flow of combustion discharge stream 31 from the combustor 12 to the nozzle 16. Thus, the enclosure 20 includes a forward end 22 and an aft end 24 for respectively receiving the combustion products and facilitating the flow of combustion discharge stream 31 in the direction of the nozzle 16. The forward end 22 of the transition piece 18 may be generally circular. In one embodiment, the transition piece 18 may transition from a circular forward end 22 generally axially and radially inwardly relative to the turbine axis and terminates in a slightly arcuate, generally rectilinear aft end 24. Located between the aft end 24 and the nozzle 16 may be an aft frame assembly 50. The aft frame assembly 50 may be generally rectilinear in shape to substantially match the shape of the aft end 24 of the transition piece 18 and may be attached to the transition piece 18 by bonding (e.g., braze, weld, etc.) the aft-frame assembly 50 to the aft end 24 via any suitable connection technique.

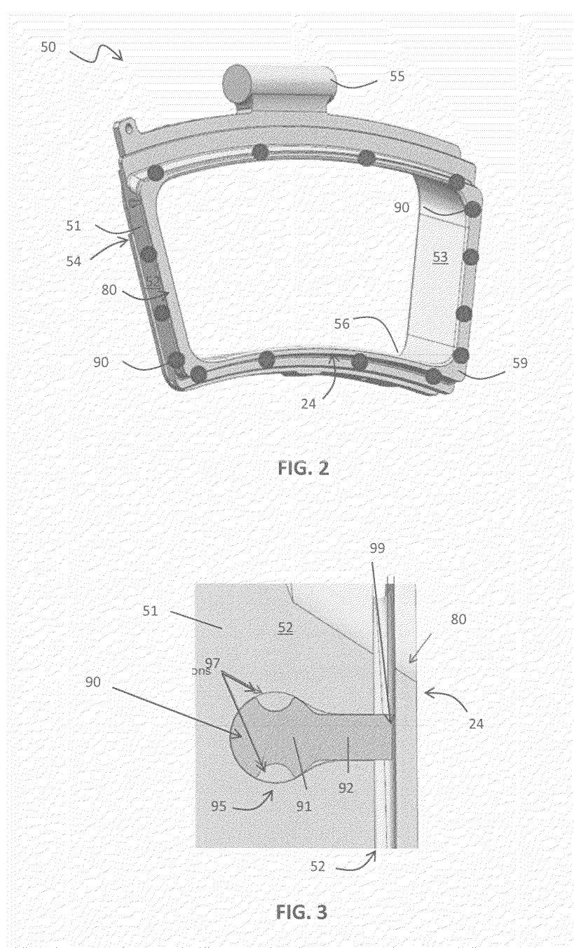

Referring now to FIGS. 2-4, an embodiment of an aft frame assembly 50 for a transition piece 18 is illustrated in accordance with one aspect of the present subject matter. The aft frame assembly 50 can generally include a body 51 that is generally rectilinear in shape. It should be readily appreciated, however, that the body 51 can have any desired shape and need not have the particular shape illustrated in FIG. 2. For instance, the aft frame assembly 50 may be circular, be in the shape of an oval or be in the shape of any suitable polygon such as by comprising a plurality of walls as illustrated. The shape of the aft frame assembly 50 will depend in large part on the particular shape and configuration of the transition piece 18.

The body 51 includes an exterior surface 52 (that faces the compressor discharge air 30) and a plurality of interior surfaces 53 (i.e., surfaces that are not the exterior surface 52 such as those facing the combustion discharge stream 31). Specifically, the body 51 comprises interior surfaces 53 that include an inner hot face surface 56 (i.e., the surface that faces the interior of the transition piece 18 facilitating the flow of combustion discharge stream 31) and a downstream facing seal surface 59 (i.e., the surface that faces the downstream nozzles and buckets of the turbine). The body 51 may also include at least one mounting hook 55 extending generally outward from the body 51. The mounting hook 55 may be configured to secure the aft-frame 50 to any combustion product receiving apparatus or device.

The body 51 may also include a laterally extending flange 54. The flange 54 can be configured such that the aft frame assembly 50 may be attached to a transition piece 18 of a combustion system. The aft frame assembly 50, for example, may be welded to the transition piece 18. In such an embodiment, an outer lip of the flange 54 may be configured such that flange 54 can be welded to the aft end 24 (i.e., the end towards the aft side of the turbine) of the transition piece 18. Additionally, the flange 54 may generally have any length and thickness. In one embodiment, the maximum flange length is 5.1 cm and the flange thickness ranges from 0.3 cm to 0.65 cm, such as from 0.4 to 0.6 and all other sub-ranges there between.

The aft frame assembly 50 may further comprise a heat shield 80 disposed proximate the aft end 24 of the body 51. The heat shield 80 can comprise any structure that is generally configured (e.g., oriented) to deflect at least a portion of the combustion discharge stream 31 away from the aft end 24 of the body 51 of the aft frame assembly 50.

For example, as illustrated in FIGS. 2-4, the heat shield 80 may generally comprise a flange-like wall that extends away from the body 51 proximate the aft end 24. The heat shield 80 and the body 51 may comprise one continuous piece such as when the heat shield 80 is machined out of the original body 51, or when the heat shield 80 is integrally bonded or joined with the body 51 (e.g., welding, brazing or the like). For example, an exterior trench 82 may be machined out of the body 51 to produce the heat shield 80. The relative thickness of the heat shield 80 and the exterior trench 82 may comprise any dimensions suitable for at least partially deflecting at least a portion of the combustion discharge stream 31 away from the aft end 24 of the body 51. In some embodiments, the heat shield 80 may comprise an additional structure that is connected (e.g., mechanically connected) to the body 51.

The heat shield 80 may extend for the entire circumference of the aft end 24 of the body 51, may extend for only a portion of the circumference of the aft end 24 of the body 51, or may extend for a plurality of portions of the circumference of the aft end 24 of the body 51 (such as in a plurality of segments). Moreover, in some embodiments the heat shield 80 may be disposed at the very edge of the aft end 24 of the body 51 such that the heat shield 80 comprises the downstream facing seal surface 59. In some embodiments, the heat shield 80 may be disposed more inboard from the edge of the aft end 24 of the body 51.

The heat shield 80 may also comprise any material or materials suitable for at least partially deflecting at least a portion of the combustion discharge stream 31 away from the aft end 24 of the body 51. For example, in some embodiments, such as when the heat shield 80 and the body 51 comprise one continuous piece, the heat shield 80 and the body 51 may comprise the same or substantially same material. In some embodiments, such as when the heat shield 80 originally comprises a separate piece that is subsequently bonded, joined, fastened or otherwise connected to the body 51, the heat shield 80 and the body 51 may comprise different materials. In some embodiments, such as when diffusion bonding and/or brazing are to be utilized, the heat shield 80 may comprise be IN625, IN617, H230, H282, GTD222, FSX414, MarM509, X40/45, L605/Haynes 25, Haynes 188 or the like. Moreover, the heat shield 80 may further comprise any coating or coatings suitable for application between a transition piece 18 and nozzle 16 in a combustion system 10.

Still referring to FIGS. 2-4, the aft frame assembly 50 can further comprise one or more heat shield supports 90. The one or more heat shield supports 90 can comprise any element connected to the body 51 and configured to at least partially restrict deflection (e.g., bending) of the heat shield 80 back towards the body 51. Such heat shield supports 90 can thereby protect the heat shield 80 during manufacturing, modification (e.g., repair), installation, operation and/or transportation by limiting its movement as a result of any external forces.

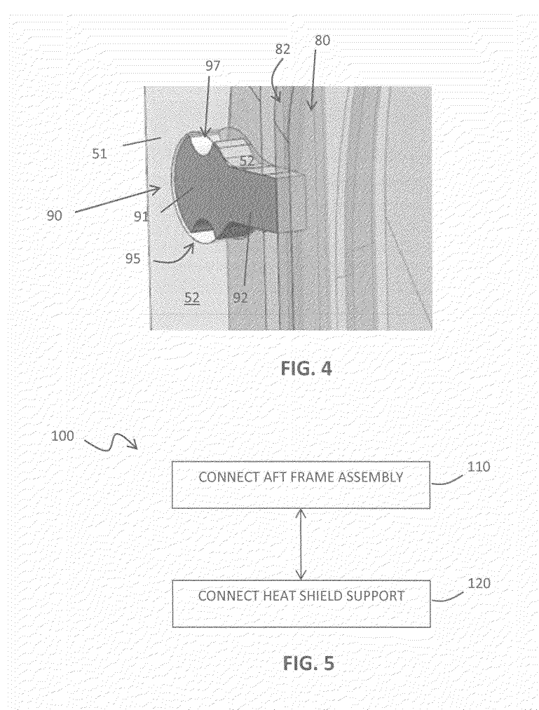

As best illustrated in FIGS. 3 and 4, in some embodiments, the heat shield support 90 may comprise a base portion 91 and a support arm 92. The base portion 91 can comprise any portion configured to connect to the body 51 while the support arm 92 can comprise any portion extending away from the base portion 91 that can at least partially physically restrict deflection of the heat shield 80 back towards the body.

For example, the base portion 91 may comprise an expanded section to increase surface area contact points with the body 51. Such embodiments may include when the base portion 91 comprises a substantially circular, oblong, oval, rectangular or similar geometry. In even some embodiments, such as that illustrated in FIGS. 3 and 4, the base portion 91 may comprise one or more connection gaps 97 comprising voids in the base portion 91 that can be utilized to secure the base portion to the body 51 (e.g., via welding) as will become appreciated herein.

Likewise, the support arm 92 can comprise any portion extending away from the body portion 91 towards the heat shield 80. The support arm 92 can comprise a rigid structure such that it would prevent the heat shield 80 from deflecting back towards the body 51. In some embodiments, the support arm 92 may comprise a generally rectangular structure as illustrated. In other embodiments, the support arm 92 may comprise any other shaped extension from the base portion 91. In even some embodiments, the heat shield support 90 may comprise a single elongated element with no clear delineation between a base portion 91 and a support arm 92. In other embodiments, the heat shield support 90 may comprise a plurality of base portions 91 and/or a plurality of support arms 92. For example, the heat shield support 90 may comprise a plurality of support arms 92 extending from a single base portion 91. Alternatively, a single support arm 92 may extend from a single base portion 91. While specific examples and configurations of heat shield supports have been described and illustrated herein, it should be appreciated that these are non-limiting and exemplary only; any alternative configuration may also be realized that is suitable for restricting deflection of the heat shield 80 towards the body 51.

The heat shield support 90 may be connected to the body 51 in a variety of configurations. For example, in some embodiments, the heat shield support 90 may be welded to the body 51. For example, in embodiments where the heat shield support comprises a base portion 91 with one or more connection gaps 97, a weld may be placed in the one or more connection gaps 97 to secure the heat shield support in place. In some embodiments, the heat shield support 90 may be brazed, staked, mechanically fastened or the like to the body 51.

The one or more heat shield supports 90 may be disposed in a variety of locations. For example, in some embodiments, the one or more heat shield supports 90 may be connected to the exterior surface 52 of the body 51. In some embodiments, the one or more heat shield supports 90 may be at least partially disposed in a recess 95 in the exterior surface 52 of the body 51 such as illustrated in FIGS. 3 and 4.

In some embodiments, the aft frame assembly 50 may comprise a plurality of heat shield supports 90. For example, as best illustrated in FIG. 2, the body 51 may comprise a plurality of walls (e.g., four walls). In such embodiments, each of the walls may comprise at least one heat shield support 90. The plurality of heat shield supports 90 may be distributed evenly or may be focused where external forces may be highest.

In some embodiments, the heat shield support 90 may contact, or even connect to, the heat shield 80 upon installation to prevent any deflection of the heat shield 80 back towards the body 51. However, in some embodiments, the heat shield support 90 may be configured to at least initially be separated from the heat shield 80 by a tolerance gap 99. The tolerance gap 99 can comprise any initial distance such that the heat shield 80 may be able to deflect towards the body 51 for the distance of the tolerance gap 99 before contacting the heat shield support 90. In such embodiments, the heat shield support 90 can at least partially restrict deflection of the heat shield 80 back towards the body 51 by limiting how much total deflection can occur.

In some embodiments, the aft frame assembly 50 can further comprise one or more exterior cooling holes fluidly connected to one or more interior cooling outlets. The one or more exterior cooling holes may be disposed on the exterior surface 52 of the body 51 for capturing compressor discharge air 30 outside of the transition piece 18. For example, the one or more exterior cooling holes may extend at an angle from the exterior surface 52 in towards the body 51. The one or more exterior cooling holes may be positioned at any relative location about the aft frame assembly 50 and have any suitable configuration/orientation that enable the capturing of compressor discharge air 30 for subsequent distribution as should be appreciated herein.

Likewise, the one or more interior cooling outlets may be disposed on one or more of the interior surfaces 53 (such as on the inner hot face surface 56 of the body 51 and/or the downstream facing seal surface 59 of the body 51) for discharging the compressor discharge air 30 that was captured from at least one of the one or more exterior cooling holes. By being positioned on the inner hot face surface 56, the one or more interior cooling outlets may discharge compressor discharge air 30 to the interior of the aft frame assembly 50 which can assist in controlling the temperature of the hot gas path components. For example, cooling outlets may be disposed on the inner hot face surface 56 to help cool the interior of the transition piece 18. Likewise, cooling outlets may be disposed on the downstream facing seal surface 59 to direct cooling air towards first stage nozzles or buckets.

In such embodiments, the one or more interior cooling outlets may be positioned at any relative location within the aft frame assembly 50 and have any suitable configuration/orientation (e.g., holes, trenches or the like) that enable the discharging of captured compressor discharge air 30. For example, in some embodiments, the aft frame assembly 50 may comprise more interior cooling outlets than exterior cooling holes due to sufficient distribution of captured compressor discharge air 30 as should be appreciated herein. Such embodiments may enable sufficient component cooling with less compressor discharge air 30 to promote better operating efficiency of the combustion system 10.

Referring now additionally to FIG. 5, a method 100 is illustrated for assembling a gas turbine transition piece. The method first comprises connecting an aft frame assembly 50 to an aft end 24 of a gas turbine transition piece 18 in step 110. As discussed above, the aft frame assembly 50 can comprise a body portion 51 comprising a downstream facing seal surface 59 on an aft end 24, at least a portion of the downstream facing seal surface 59 configured to be exposed to a combustion discharge stream 31. The aft frame assembly 50 connected to the gas turbine transition piece 18 in step 110 further comprises a heat shield 80 disposed proximate the aft end 24 of the body 51, wherein the heat shield 80 is configured to deflect at least a portion of the combustion discharge stream 31 away from the aft end 24 of the body 51.

With continued reference to FIG. 5, the method 100 further comprises connecting one or more heat shield supports 90 to the body 51 in step 120. As discussed above, the one or more heat shield supports 90 can be configured to at least partially restrict deflection of the heat shield 80 back towards the body 51. Connecting the one or more heat shield supports 90 in step 120 can occur before, after, simultaneous with, or combinations thereof, connecting the aft frame assembly 50 to the gas turbine transition piece 18 in step 110 of method 100.

It should now be appreciated that heat shield supports can at least partially restrict deflection of the heat shield back towards the body in an aft frame assembly of a transition piece by physically blocking and/or supporting the heat shield. One or more heat shield supports may thereby help protect the heat shield by helping it maintain its shape and position in light of any external forces that may be experienced during manufacturing, modification (e.g., repair), installation, operation and/or transportation.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. An aft frame assembly for an aft end of a gas turbine transition piece, the aft frame assembly comprising:
a body comprising a downstream facing seal surface on an aft end, at least a portion of the downstream facing seal surface configured to be exposed to a combustion discharge stream;
a heat shield disposed proximate the aft end of the body, wherein the heat shield is configured to deflect at least a portion of the combustion discharge stream away from the aft end of the body; and,
one or more heat shield supports connected to the body and configured to at least partially restrict deflection of the heat shield back towards the body.

2. The aft frame assembly of claim 1, wherein the teat shield and the body comprise one continuous piece.

3. The aft frame assembly of claim 1, further comprising an exterior trench separation at a least a portion of the heat shield from the body.

4. The aft frame assembly of claim 1, wherein the one or more heat shield supports are connected to an exterior surface of body.

5. The aft frame assembly of claim 1, wherein the one or more heat shield supports are at least partially disposed in a recess in an exterior surface of the body.

6. The aft frame assembly of claim 1, wherein the one or more heat shield supports comprise a support arm extending from a base portion.

7. The aft frame assembly of claim 6, wherein the base portion is connected to an exterior surface of the body.

8. The aft frame assembly of claim 7, wherein the base portion and the support arm are at least partially disposed in a recess in the exterior surface of the body.

9. The aft frame assembly of claim 6, wherein the base portion comprises one or more connection gaps, and wherein the base portion is connected to the body by welding at the one or more connection gaps.

10. The aft frame assembly of claim 1, wherein at least one heat shield support is configured to at least initially be separated from the heat shield by a tolerance gap.

11. The aft frame assembly of claim 1, wherein the body comprises a plurality of walls.

12. The aft frame assembly of claim 11, wherein each of the plurality of walls comprise at least one heat shield support.

13. The aft frame assembly of claim 1, wherein the heat shield comprises the downstream facing seal surface.

14. The aft frame assembly of claim 1, further comprising one or more exterior cooling holes fluidly connected to one or more interior cooling outlets.

15. A method for assembling a gas turbine transition piece, the method comprising:
connecting an aft frame assembly on an aft end of the gas turbine transition piece, the aft frame assembly comprising:
a body comprising a downstream facing seal surface on an aft end, at least a portion of the downstream facing seal surface configured to be exposed to a combustion discharge stream; and,
a heat shield disposed proximate the aft end of the body, wherein the heat shield is configured to deflect at least a portion of the combustion discharge stream away from the aft end of the body; and,
connecting one or more heat shield supports to the body, wherein the one or more heat shield supports are configured to at least partially restrict deflection of the heat shield back towards the body.

16. The method of claim 15, wherein the one or more heat shield supports comprise a support arm extending from a base portion.

17. The method of claim 16, wherein the base portion comprises one or more connection gaps, and wherein connecting the one or more heat shield supports comprises welding at the one or more connection gaps.

18. The method of claim 15, wherein connecting the one or more heat shield supports to the body comprises connecting the one or more heat shield supports to an exterior surface of the body.

19. The method of claim 15, wherein the body comprises a plurality of walls, and wherein connecting the one or more heat shield supports to the body comprises connecting at least one heat shield support to each of the walls.

20. The method of claim 15, wherein connecting the one or more heat shield supports comprises separating at least one heat shield support from the heat shield by a tolerance gap.
